(19) United States
(12) Patent Application Publication
(10) Pub. No.: US 2023/0029720 A1
(43) Pub. Date: Feb. 2, 2023

(54) TAP

(71) Applicant: Hawa Valves & Tubes Pvt. Ltd., Mumbai (IN)

(72) Inventor: Javed Anwar HAWA, Mumbai (IN)

(21) Appl. No.: 17/779,401

(22) PCT Filed: Oct. 9, 2020
(86) PCT No.: PCT/IB2020/059493

§ 371 Date: May 24, 2022

(30) Foreign Application Priority Data
Dec. 3, 2019 (GB) 1917659.3

(51) Int. Cl. E03C 1/04; F16K 31/60

(52) U.S. Cl. CPC E03C 1/0412; F16K 31/602

(57) ABSTRACT

A tap is provided, comprising: a water inlet for connecting to a supply of water; a water outlet for dispensing a stream of water; a fluid passageway connecting the water inlet and outlet; and a valve provided in the fluid passageway. The valve comprises a valve element and a valve seat. The valve element is moveable between an open position in which a fluid can flow through the passageway to a closed position where the valve element seals with the valve seat to inhibit fluid flowing through the passageway. An actuator extends out of the water outlet. The actuator is arranged to move the valve element against a flow direction between the open and closed positions.

### BACKGROUND

The problem of water wastage is generally well-known across the globe. This problem is particularly relevant in areas which may suffer from drought conditions, but likewise is applicable to any situation where water is supplied on a metered basis. Typically, there is a large amount of water wastage from users leaving taps running for longer than is necessary. For example, users may leave a tap running while they are carrying out other tasks near to the sink. There is also the risk of a user accidently leaving a tap open when they leave the sink and thereby wasting large amounts of water.

Various devices to reduce the waste of water have been developed. Typically, these include an electronic sensor which detects the presence of a person's hands beneath the tap. Once the electronic sensor detects the person's hands, a flow of water is then initiated. Once the user's hands are removed, the sensor detects accordingly and the flow of water is stopped.

However, these solutions require expensive electronic components and an electrical connection. This means that replacement of the battery and sensors and maintenance thereof will become necessary in due course. Furthermore, in many drought situations where metering of water is necessary, there is not an electrical connection available. This may be particularly true in natural disaster situations where electricity may be limited or not available and water may also be in short supply.

There is therefore a need for an improved tap.

U.S. Pat. No. 4,940,206 A discloses a faucet of which the displacement of the valve cock is controlled through pressure equilibrium effect, which includes a draw-off tap assembly comprised of a casing, a valve cotter, a valve cock, a sealing plug, wherein the valve cock is mounted on the valve cotter, and the valve cotter is set in a cavity defined by the casing and the sealing plug with the rear end of the valve cotter being arranged to protrude beyond the water passage of said sealing plug.

US 2009/242819 A1 discloses an adjustable water valve of time-controlled type consisting of an inner shell and a time-controlled apparatus.

DE 3500564 C1 discloses a device for triggering water discharge in the case of a water tap having a switching device which can be actuated by positioning hands in a region beneath a discharge head of the water tap.

FR 2805879 A1 discloses control of water flow from a tap by a user pressing their hands against a vertical lever extending from a nozzle of the tap.

U.S. Pat. No. 4,512,551 A discloses a device for releasing a flow of water in a water faucet including switching means adapted to be actuated by movement of the hands to be washed into an area under a discharge head of the water faucet.

U.S. Pat. No. 5,286,000 A discloses a wand activated dispensing valve that can be installed on spouts of water faucets.

US 2014/290762 A1 discloses a rod activated water valve for installation on a threaded water faucet, tap or threaded pipe with a filter screen to prevent particles larger than the filter mesh from passing through the filter.

### SUMMARY

The present invention provides a tap according to claim 1. This tap allows for the flow of water to be triggered only during use without the need for complex electronic components. The flow direction is the direction that water flows from the tap for the user to wash their hands.

The valve element may be integral with the actuator. This allows for a simple design which is easy to manufacture and assemble.

The actuator may be an elongate rod and the valve element may be formed as an annular projection from the elongate rod. This is a simple design for the actuator and valve element.

The annular projection may comprise a tapered outer surface for engaging with the valve seat. This allows for a better seal between the valve element and valve seat.

The valve element and/or actuator may be biased towards the closed position. This shuts the flow of fluid off automatically.

The tap may further comprise a damper arranged to dampen and/or limit oscillations of the actuator. This inhibits damage to the tap and can also prevent over-actuation.

The valve element and/or actuator may be biased towards the closed position with a coil spring, and the dampener may be arranged within the coils of the coil spring. This is a simple design for the dampener which can be easily assembled.

The actuator may extend generally parallel to a direction of fluid flow exiting the water outlet. This means that the actuator is generally under the flow of water when the tap is actuated.

The tap may further comprise a valve housing coupled to the tap, the valve housing comprising the valve seat and retaining the actuator. This allows quick attachment of the actuator to the tap.

The present invention also provides the use of an actuator extending out of a water outlet of a tap according to claim 16.

The present invention also provides the user of a dampener within the coils of a coil spring to dampen and/or limit the oscillations of an actuator extending out of a water outlet of a tap according to claim 17.

### BRIEF DESCRIPTION OF THE FIGURES

The present invention will now be described by way of example only, with respect to the accompanying figures in which:

FIG. 1 shows a cross-section view of a tap according to the present invention;

FIG. 2 shows an exploded perspective view of the tap of FIG. 1;

FIG. 3 shows a perspective assembled view of the tap of FIG. 1;

FIG. 4 shows a side assembled view of the tap of FIG. 1;

FIGS. 5A, 5B, 5C, 5D and 5E show the tap of FIG. 1 in various use situations;

FIG. 6 shows a cross-section view of an alternative tap according to the present invention; and

FIGS. 7A and 7B show exploded perspective views of the tap of FIG. 6.

### DETAILED DESCRIPTION OF THE FIGURES

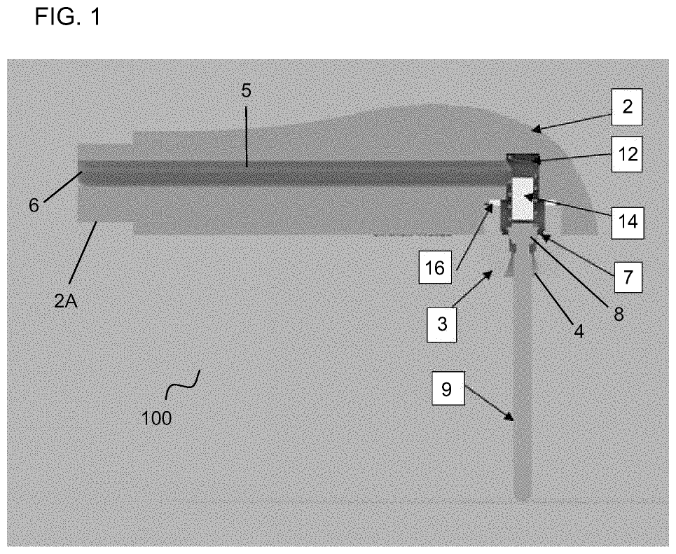

As shown in FIG. 1, the present invention is a tap (or faucet) 100. The tap 100 may have a tap body 2 which includes a water inlet 6 and a water outlet 4. The tap body 2 may include a connection portion 2A for connecting to a faucet body or the like, attached to a source of water such as mains water. A fluid passageway 5 connects the water inlet 6 and the water outlet 4. As can be seen in FIG. 1, it is not necessary for the tap body 2 to be formed of a single integral unit. Instead, there may be additional connection units such as the valve housing 3 shown in FIG. 1 collectively forming the tap body 2. This valve housing 3 may connect to the rest of the tap 100 via any known method such, as, for example, complementary engaged threads or a push-fit. Likewise, the fluid flow passageway 5 may include turns or twists in its path.

A valve is provided within the fluid passageway 5. This valve comprises a valve element 8 and a valve seat 7. The valve element 8 is selectively sealable with the valve seat 7 in order to allow and prevent a flow of fluid, in particular a liquid such as water, through the tap 100. The valve element 8 may be moved between an open position in which a fluid can flow through the passageway 5 and out of the water outlet 4, and a closed position. In this open position, the valve element 8 is generally disengaged from the valve seat 7 at one or more points around its periphery. There is likewise a closed position in which the valve element 8 is engaged with the valve seat 7 around is periphery to seal therewith. The fluid channel 5 is then blocked and fluid is then prevented from flowing through the tap 100 and from the outlet 4. The valve element 8 is moved between these positions in a flow direction. The flow direction being the direction that water is expelled from the tap for the user to wash their hands. For example, the flow direction may be generally vertical (i.e. falling under gravity). That is, to move from the open position to the closed position the valve element 8 may move in the flow direction, and to move from the closed position to the open position the valve element 8 may move opposite the flow direction.

In a particular embodiment, the valve seat 7 may be formed as a generally circular bore with an internal shoulder. In the simplest form, this may be formed by a bore of a first wider diameter narrowing to a bore of a second diameter and forming a shoulder therebetween. The bores of each diameter may be formed separately and attached to one another, for example by screwing two components together. The shoulder may further be provided with a sealing element which may sit in a recessed face of the shoulder. The valve element 8 may then consist of a complementary shaped plug which abuts the shoulder to block the flow of fluid. This play may dig into a sealing element provided on the shoulder to enhance the seal. In alternative embodiments, the plug may comprise a sealing element to contact the shoulder. When the plug is displaced from the shoulder by any distance at any point around its periphery, the fluid is able to flow past the plug through the valve to the outlet 4.

The valve element 8 and seat 7 may be provided within a valve housing 3. As discussed above, the valve housing 3 may be integral with the rest of the tap 100 or may be attachable thereto. The valve housing 3 may comprise a central bore and an inner shoulder for retaining the valve seat 7. This inner shoulder may act to retain the valve element 8 within the tap 100. As can be seen in FIG. 1, the relative sizes of these components ensures that the valve element 8 cannot be removed without first removing the valve housing 3. A body seal 16 may be provided between the valve housing 3 and the rest of the tap 100 in order to ensure that no fluid can leak through the interface between these components.

An actuator 9 is provided extending from the water outlet 4. That is, a distal portion of the actuator 9 is arranged generally within the opening of the water outlet 4. In this sense, and as will be discussed in more detail later, when the user touches the actuator 9 to move it, they will be required to place their hands under the outlet 4 where a flow of water through the tap 100 would naturally flow under gravity in use. The actuator 9 is attached to the valve element 8 and is arranged to move this valve element 8 between the open and closed positions. As depicted in FIG. 1, the valve element 8 and the actuator 9 may be integrally formed. In particular, in this depicted embodiment the actuator 9 is formed as an elongate rod and the valve element 8 is formed as an annular protrusion from this elongate rod. In this sense, the valve element 8 is a portion with a greater radial diameter than the remainder of the elongate rod 9. The outer surface of the valve element 8 may be generally tapered in a direction away from the valve seat 7 so as to provide a suitable sealing surface for engaging with the valve seat 7. That is, the valve element 8 may be a conical, annular protrusion. However, any alternative construction for the valve element 8 and actuator 9 may be used. The actuator 9 may be arranged to move the valve element 8 in a flow direction and against (or opposite) a flow direction between the open and closed positions.

In the depicted embodiment, a biasing means such as spring 12 is provided to bias the valve element 8 towards the closed position in which it engages the valve seat 7. The biasing element may be any suitable biasing element but a spring is generally preferred for convenience. The spring 12 may be in the form of a coil spring. The coil spring may be biased so to encourage the valve element 8 towards the valve seat 7 to thereby seal the components together and block the fluid passageway 5. However, it is not strictly necessary to include the biasing element 12 and certain embodiments of the design may omit this component. In embodiments without the biasing element 12, the flow of fluid/water through the tap 100 may be sufficient to force the valve element 8 to contact the valve seat 7 and thereby prevent the flow of fluid.

A damper 14 is provided in conjunction with the biasing element 12. In the depicted embodiment where the biasing element 12 is a coil spring 12, the damper 14 may be provided within the coils of the coil spring 12. In particular, the damper 14 may be a small rod between the coils of the coil spring 12. This small rod may be generally resiliently deformable to act as the damper 14. The damper 14 is arranged to dampen and/or limit oscillations of the actuator 9. The damper 14 will act to prevent the valve element 8 and hence actuator 9 from oscillating and causing a hydraulic shock or water hammer effect. This effect is caused when a pipe outlet is suddenly closed and the mass of water before the closure is still moving, thereby building up high pressure and a resulting shock wave. In domestic plumbing this is experienced as a loud banging resembling a hammering noise. The damper 14 may slow the closure of the valve and hence reduce this effect. The damper 14 may also prevent the actuator 9 from excessive opening of the valve element 8.

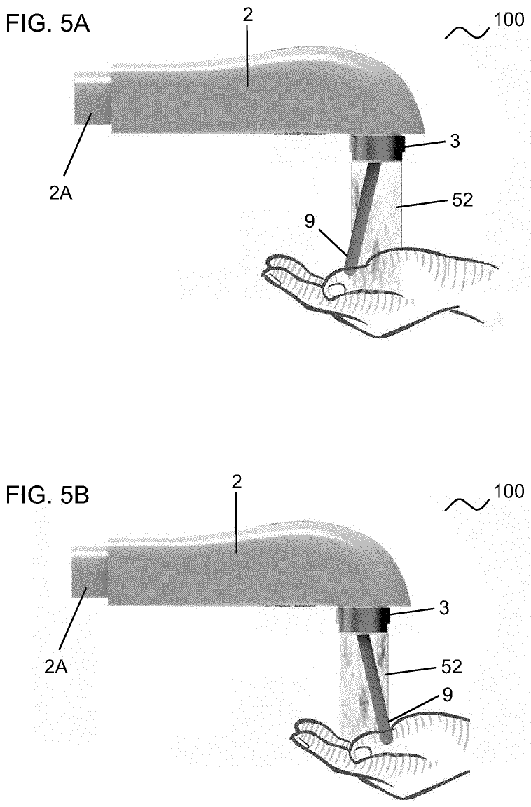

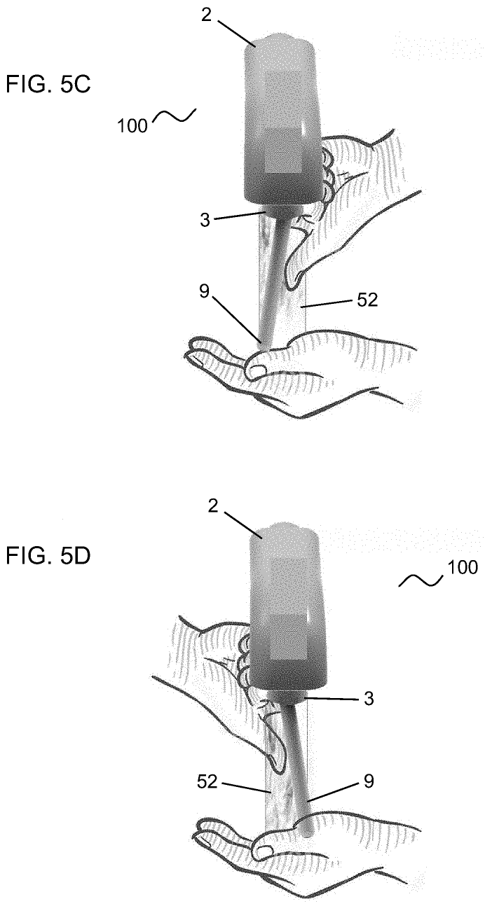

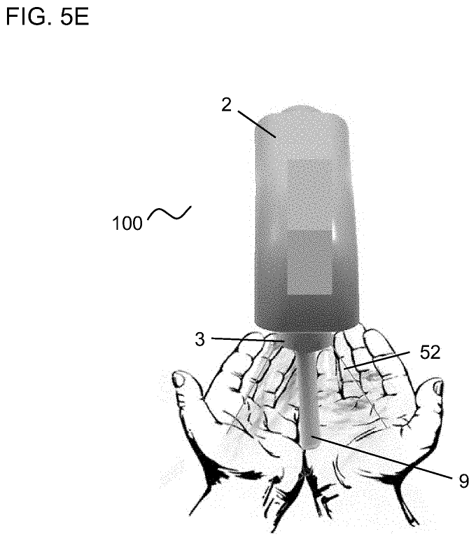

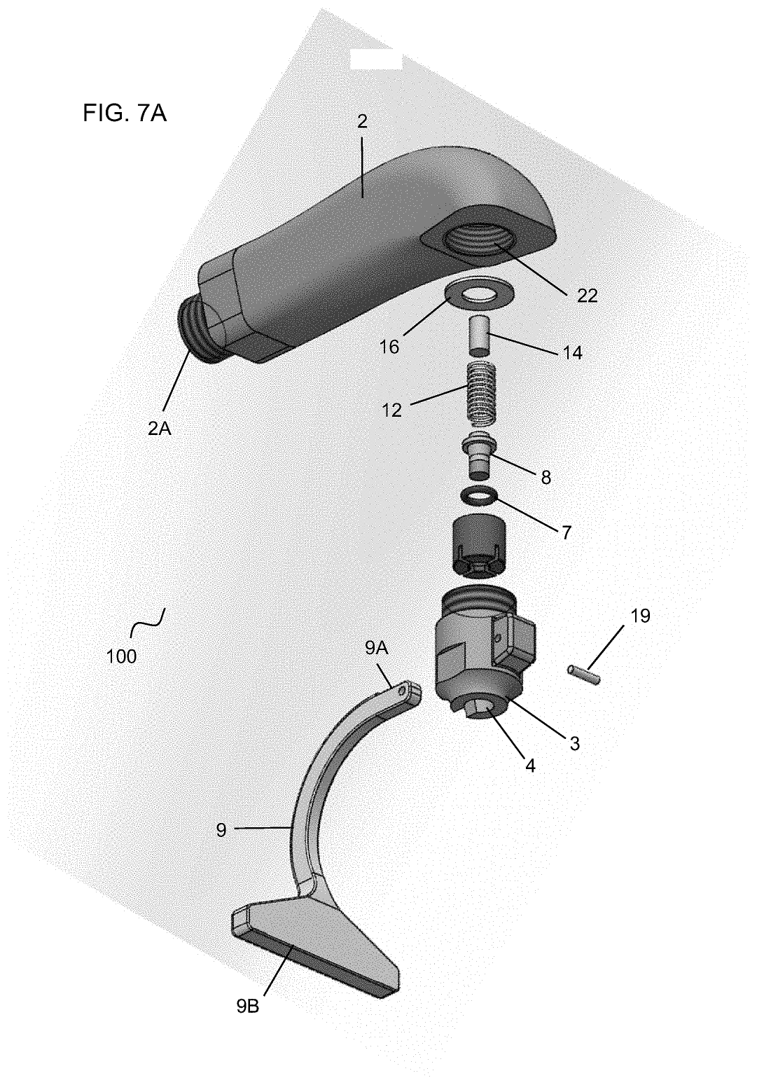

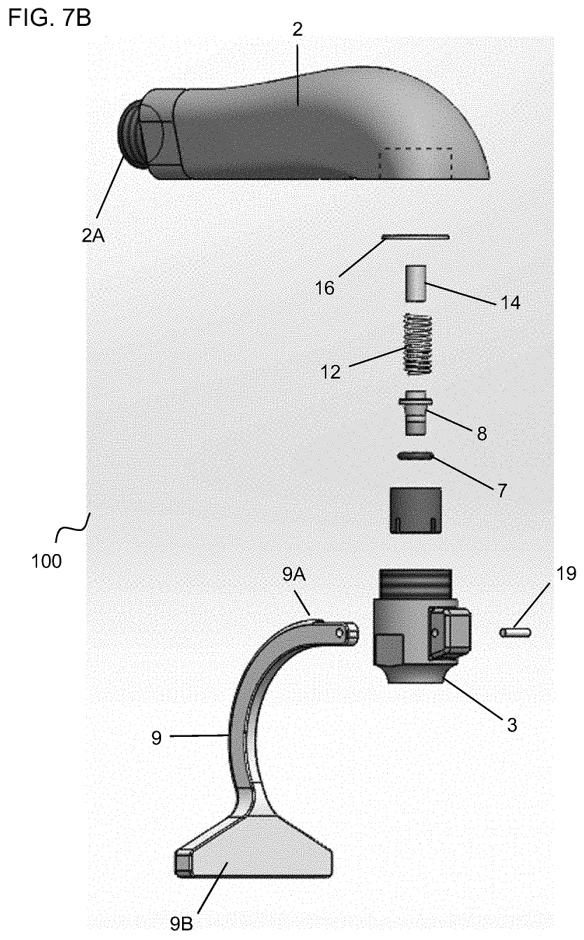

Actuation of the tap 100 will now be described with respect to FIGS. 5A to 5E. In general, a user places the hands below the outlet 4 and presses on the actuator 9. As the actuator 9 and valve element 8 are retained within the tap 100 such that they are moveable axially upwards, but not down, rotatable about this axis and pivotable relative to this axis they may be moved in any direction in order to dislodge the valve element from the valve seat 7 to allow the flow of water. For example, FIG. 7 shows the actuator 9 and hence valve element 8 being pushed away from the user while FIG. 5B shows the opposite with the actuator 9 and hence valve element 8 being pulled towards the user. Likewise, FIGS. 5C and 5D show the actuator 9 and valve element 8 being pushed to the left and right respectively. In each of these modes of operation, a portion of the valve element 8 contacts the valve housing 3 to pivot about this contact point. A further portion of the valve element 8 will then disengage from the valve seat 7 to allow a fluid flow through the tap unit 100.

FIG. 5E shows the actuator 9 and hence valve element 8 being pushed upwards in order to actuate the device. Generally, the entire periphery of the valve element 8 will be disengaged from the valve seat 7 in this mode of operation to allow flow of fluid through the tap 100.

Each of these movements dislodges the valve element 8 from the valve seat 7 and hence allows a flow of water 52 to pass through the outlet 4. As shown in each of these Figures, the actuator 9 is generally provided such that, in use, it is under the water outlet 4 such that the flow of water 52 passes over the device. Accordingly, as the user actuates the actuator 9 their hands will necessarily be under the flow of water 52 in order to receive this flow. Once the user moves away from the device the flow of water will naturally cease and the biasing means will return the valve element 8 to the closed position.

In this sense, the tap 100 may be actuated simply by a user placing their hands under the outlet 4 and displacing the actuator 9. This allows waste water to be minimised without the use of complex and energy expensive electronic components.

Of course, the flow of water does not have to be actuated by a user's hands but can instead be actuated by any other object brought into contact with the actuator 9. This may include vessels to be filled, fabric to be wetted such as cleaning cloths, or the like.

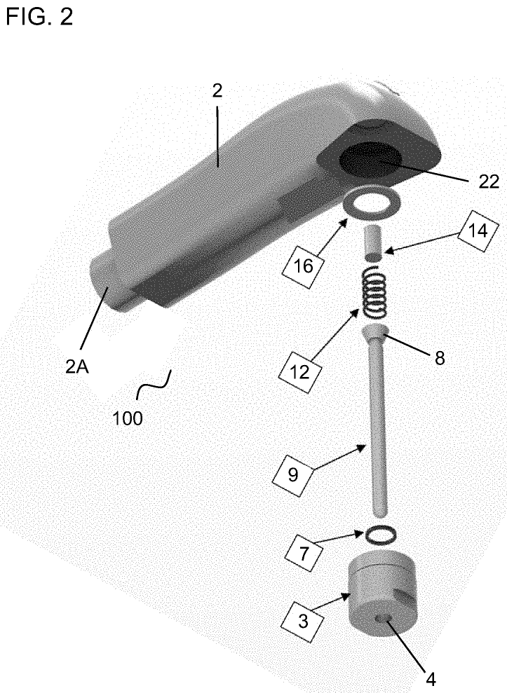

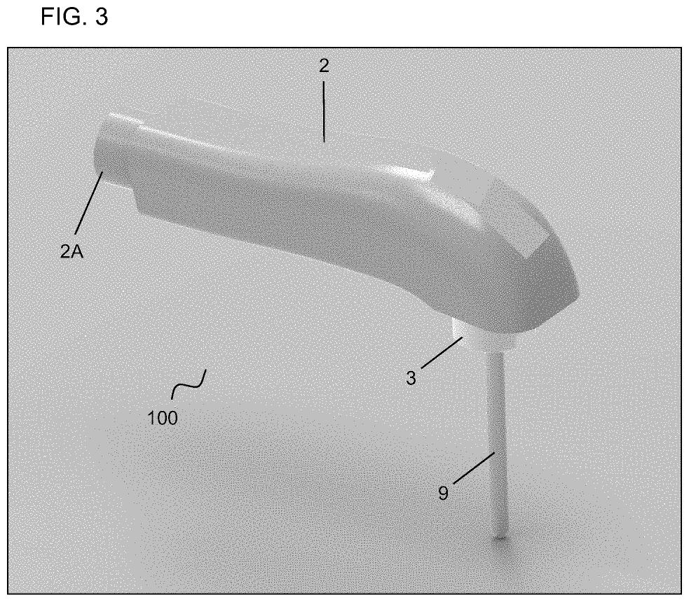

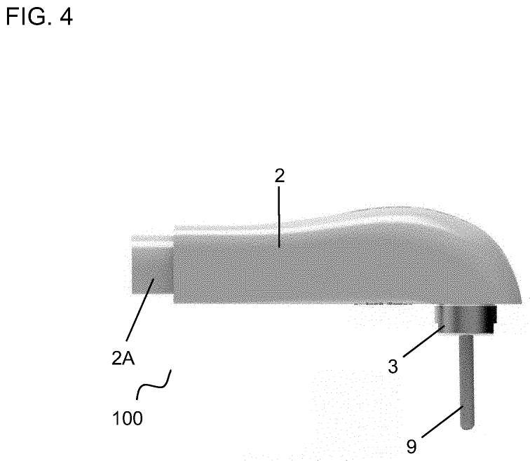

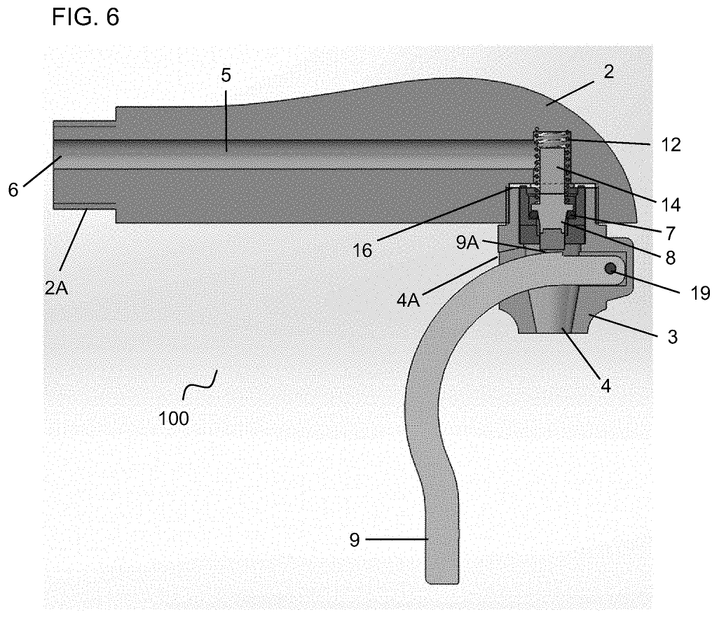

FIGS. 6, 7A and 7B show an alternative tap 100. This alternative tap 100 is generally similar to the tap described in relation to FIGS. 1 to 5E. Unless expressly noted otherwise, any disclosure in relation to the tap 100 of FIGS. 1 to 5E is equally applicable to the tap of FIGS. 6 to 7B, and vice versa.

The primary difference between the tap 100 of FIGS. 6 to 7B relates to the shape of the actuator 9. As shown in FIG. 6, the actuator 9 still extends out of the water outlet 4, via a side passage 4A. The side passage 4A may be formed in the valve housing 3. In use, water flowing through the water outlet 4 passes the actuator 9. The actuator 9 may be pivotably connected to the valve housing 3, for example about an actuator pin 19. The actuator 9 may include a contact point 9A arranged to contact the valve element 8. As the actuator 9 is pivoted about the actuator pin 19, the contact point 9A bears against the valve element 8 to move it towards and away from the valve seat 7 to selectively inhibit and allow flow of water through the tap 100.

In this alternative tap 100, the valve element 8 is separate to the actuator 9, that is not integral therewith. As such, the valve element 8 is a freely floating. The valve element is biased towards the closed position by the biasing means 12, such that it is self-sealing.

The actuator 9 may comprise an offset portion 9B, arranged for the user to press. The offset portion 9B is offset from an axis passing through the water outlet 4. In particular, a central axis of the water outlet 4. In use, water flowing through the water outlet 4 will generally travel in the direction of this central axis. The offset portion 9B may be larger than the remaining portion of the actuator 9. The actuator 9 may be generally curved so as to offset the offset portion 9B from the central axis. In particular, the actuator may curve through 90 degrees. The actuator may be curved through at least 70 degrees or at least 80 degrees. The actuator may be curved through no more than 110 degrees. As a result, the offset portion 9B may be actuated by a user in a first direction, with the contact point 9A moving in a second direction generally transverse, or perpendicular, to the first direction.

The offset portion 9B may be offset towards the connection portion 2A, away from the water outlet 4. In use, the connection portion 2A will be arranged away from the user in the sink. Thus, to actuate the offset portion 9B the user must reach beyond the water outlet 4, deeper into the sink. Thus, the user's hands will be underneath the water outlet 4 when they press the offset portion 9B.

To improve the ease of manufacture and support of the valve element 8, the housing 3 may further comprise an inner housing component 3A. The inner housing component 3A is received within the main housing 3. The inner housing component 3A includes the valve seat 7 and retains the valve element 8 in position. The inner housing component 3A may include a central bore which has a smaller diameter than a sealing surface of the valve element 8, thereby ensuring that the valve element 8 is retained in place. This can also provide the valve seat 7. The inner housing component 3A may be retained against an internal shoulder of the main housing 3.

Use of the alternative tap 100 of FIGS. 6 to 7B is generally as described above in relation to the tap 100 of FIGS. 1 to 5. The user presses against the offset portion 9B, which causes the actuator 9 to pivot about the actuator pin 19. This pivoting movement causes the contact point 9A to press against the valve element 8. This pressing causes the valve element 8 to separate from the valve seat 7. As a result, water in the tap 100 can flow past the valve element 8 and valve seat 7 to the water outlet 4. As a result of the arrangement of the tap 100, water flowing from the water outlet 4 necessarily contacts the user's hand(s) which are pressing the offset portion 9B.

1. A tap comprising:
a water inlet for connecting to a supply of water;
a water outlet for dispensing a stream of water;
a fluid passageway connecting the water inlet and outlet;
a valve provided in the fluid passageway, comprising a valve element and a valve seat, the valve element moveable between an open position in which a fluid can flow through the passageway to a closed position where the valve element seals with the valve seat to inhibit fluid flowing through the passageway; and
an actuator extending out of the water outlet, the actuator arranged to move the valve element between the open and closed positions.

2. The tap of claim 1, wherein the valve element and/or actuator are biased towards the closed position.

3. The tap of claim 2, further comprising a damper arranged to dampen and/or limit oscillations of the actuator.

4. The tap of claim 3, wherein the valve element and/or actuator are biased towards the closed position with a coil spring and because of natural self-sealing using the pressure and flow, and the dampener is arranged within the coils of the coil spring.

5. The tap of claim 4, wherein the actuator extends in a direction of fluid flow exiting the water outlet.

6. The tap of claim 5, further comprising a valve housing coupled to the tap, the valve housing comprising the valve seat and retaining the actuator.

7. The tap of claim 6, wherein the valve element is integral with the actuator.

8. The tap of claim 7, wherein the actuator is an elongate rod or lever and the valve element is formed as a annular projection from the elongate rod.

9. The tap of claim 8, wherein the radial projection comprises a tapered outer surface for engaging with the valve seat.

10. The tap of claim 6, wherein the water outlet defines a central axis for a flow of water, and the actuator comprises an offset portion offset from this central axis.

11. The tap of claim 10, wherein the offset portion is offset towards a connection portion of the tap, the connection portion for attachment to a water source.

12. The tap of claim 11, wherein the actuator is moveable in a direction generally transverse to the central axis to move the valve element.

13. The tap of claim 1, wherein the actuator is pivoted to move against the valve element

14. The tap of claim 1, wherein the actuator is curved.

15. The tap of claim 14, wherein the actuator is curved through at least 70 degrees.

16. Use of an actuator extending out of a water outlet of a tap to move a valve element between open and closed positions to trigger flow of fluid through the tap.

17. Use of an dampener within the coils of a coil spring to dampen and/or limit the oscillations of an actuator extending out of a water outlet of a tap, the actuator arranged to move a valve element between open and closed positions to trigger flow of fluid through the tap and the coil spring biasing the valve element and/or actuator towards the closed position.
